(19) United States
(12) Patent Application Publication
(10) Pub. No.: US 2025/0238123 A1
(43) Pub. Date: Jul. 24, 2025

(54) ELECTRONIC DEVICE AND METHOD FOR CO-EDITING IN MULTIPLE DEVICE ENVIRONMENT

(71) Applicant: SAMSUNG ELECTRONICS CO., LTD., Suwon-si (KR)

(72) Inventor: Jungwan PARK, Suwon-si (KR)

(73) Assignee: SAMSUNG ELECTRONICS CO., LTD., Suwon-si (KR)

(21) Appl. No.: 19/177,034

(22) Filed: Apr. 11, 2025

Related U.S. Application Data
(63) Continuation of application No. PCT/KR2023/013817, filed on Sep. 14, 2023.

(30) Foreign Application Priority Data
Oct. 14, 2022 (KR) 10-2022-0132529
Oct. 18, 2022 (KR) 10-2022-0134477

(51) Int. Cl. G06F 3/04842; G06F 3/04845; G06F 3/04883; G06F 3/14

(52) U.S. Cl. CPC G06F 3/04842; G06F 3/04845; G06F 3/04883; G06F 3/1454

(57) ABSTRACT

An electronic device includes: a display; and at least one processor operatively connected to the display and configured to: receive, from an external electronic device, first information representing a first set of user inputs of the external electronic device connected to the electronic device, receive, from the external electronic device, the first information and second information representing a second set of user inputs with respect to the first set of user inputs, display, via the display, first contents corresponding to the first set of user inputs, based on the first information, and display, via the display, second contents corresponding to the first set of user inputs and the second set of user inputs, based on the first information and the second information.

### CROSS-REFERENCE TO RELATED APPLICATIONS

This application is a by-pass continuation application of International Application No. PCT/KR2023/013817, filed on Sep. 14, 2023, which is based on and claims priority to Korean Patent Application No. 10-2022-0132529, filed on Oct. 14, 2022, and Korean Patent Application No. 10-2022-0134477, filed on Oct. 18, 2022, in the Korean Intellectual Property Office, the disclosures of which are incorporated by reference herein their entireties.

### BACKGROUND

### 1. Field

The disclosure relates to an electronic device and a method for co-editing in a multiple device environment, and more particularly, to the electronic device and the method for performing real-time co-editing in the multiple device environment.

### 2. Description of Related Art

Co-editing means that the same document is edited by a plurality of users simultaneously. In a network in which a plurality of devices are connected, each device's user may freely edit the same document, and edited content may be delivered to another device (to another user) in real-time by being configured according to a promised rule and may be expressed on each device. In other words, in a real-time co-editing environment, based on a solution (or rule, algorithm) for co-editing, edits from a specific device may be delivered to another device and expressed in a completed form in a promised format.

### SUMMARY

According to an aspect of the disclosure, an electronic device includes: a display; and at least one processor operatively connected to the display and configured to: identify whether a number of a first set of user inputs received while a timer is activated reaches a reference number, based on identifying that the number of the first set of user inputs reaches the reference number before the timer is expired or identifying that the timer is expired, reset the timer and transmit, to an external electronic device, first information representing the first set of user inputs, identify whether a number of a second set of user inputs received while the reset timer is activated reaches the reference number, and based on identifying that the number of the second set of user inputs reaches the reference number before the reset timer is expired or identifying that the reset timer is expired, transmit, to the external electronic device, the first information and second information representing the second set of user inputs with respect to the first set of user inputs.

The at least one processor may be further configured to activate the timer based on identifying obtaining the first set of user inputs.

The at least one processor may be further configured to identify reference time related to a length of the timer and the reference number, based on a data rate of a network including the electronic device and the external electronic device.

First contents corresponding to the first set of user inputs may be displayed, via a display of the external electronic device, at first time based on the first information, wherein second contents corresponding to the first set of user inputs and the second set of user inputs may be displayed, via the display of the external electronic device, at second time based on the first information and the second information, and wherein the first time may precede the second time.

The second contents, which correspond to the first set of user inputs and the second set of user inputs, may include the first contents corresponding to the first set of user inputs.

The first information may include at least one of position information, pressure information, tilt information, or time information for the first set of user inputs, and wherein the second information may include at least one of position information, pressure information, tilt information, or time information for the second set of user inputs.

The position information may indicate a direction from a user input to another user input after the user input, wherein the pressure information may indicate a pressure pressing in a perpendicular direction of the display, wherein the tile information may indicate an angle between a central axis in which a user input is inputted and the perpendicular direction of the display, and wherein the time information may indicate a time when a user input is inputted.

According to an aspect of the disclosure, a method performed by an electronic device, includes: identifying whether a number of a first set of user inputs received when a reset timer is activated reaches a reference number, based on identifying that the number of the first set of user inputs reaches the reference number before the timer is expired or identifying that the timer is expired, resetting the timer and transmitting, to an external electronic device, first information representing the first set of user inputs, identifying whether a number of a second set of user inputs received when the reset timer is activated reaches the reference number, and based on identifying that the number of the second set of user inputs reaches the reference number before the reset timer is expired or identifying that the reset timer is expired, transmitting, to the external electronic device, the first information and second information representing the second set of user inputs with respect to the first set of user inputs.

The method may include activating the timer based on identifying obtaining the first set of user inputs.

The method may further include identifying reference time related to a length of the timer and the reference number, based on a data rate of a network related to the electronic device and the external electronic device.

The method may further include: displaying, via a display of the external electronic device, first contents corresponding to the first set of user inputs at first time, based on the first information, and displaying, via the display of the external electronic device, second contents corresponding to the first set of user inputs and the second set of user inputs at second time, based on the first information and the second information, and wherein the first time may precede the second time.

The second contents, which correspond to the first set of user inputs and the second set of user inputs, may include the first contents corresponding to the first set of user inputs.

The first information may include at least one of position information, pressure information, tilt information, or time information for the first set of user inputs, and wherein the second information may include at least one of position information, pressure information, tilt information, or time information for the second set of user inputs.

The position information may indicate a direction from a user input to another user input after the user input, wherein the pressure information may indicate a pressure pressing in a perpendicular direction of the display, wherein the tile information may indicate an angle between a central axis in which a user input is inputted and the perpendicular direction of the display, and wherein the time information may indicate a time when a user input is inputted.

According to an aspect of the disclosure, an electronic device include: a display; and at least one processor operatively connected to the display and configured to: receive, from an external electronic device, first information representing a first set of user inputs of the external electronic device connected to the electronic device, receive, from the external electronic device, the first information and second information representing a second set of user inputs with respect to the first set of user inputs, display, via the display, first contents corresponding to the first set of user inputs, based on the first information, and display, via the display, second contents corresponding to the first set of user inputs and the second set of user inputs, based on the first information and the second information.

The at least one processor may be further configured to consecutively display the second contents with respect to the first contents, based on the first information and the second information.

The first information may include at least one of position information, pressure information, tilt information, or time information for the first set of user inputs, and wherein the second information may include at least one of position information, pressure information, tilt information, or time information for the second set of user inputs.

The position information may indicate a direction from a user input to another user input after the user input, wherein the pressure information may indicate a pressure pressing in a perpendicular direction of the display, wherein the tile information may indicate an angle between a central axis in which a user input is inputted and the perpendicular direction of the display, and wherein the time information may indicate a time when a user input is inputted.

The at least one processor may be further configured to: identify whether a difference between first time when the first information is received and second time when the first information and the second information are received is equal to reference time, based on the difference being equal to the reference time, configure an animation for displaying the second contents during the reference time, based on the difference being not equal to the reference time, configure the animation for displaying the second contents during time corresponding to the difference, and display, via the display, the second contents based on the configured animation.

The at least one processor may be further configured to identify the reference time, based on a data rate of a network between the electronic device and the external electronic device or is a predetermined value.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to one or more embodiments;

FIG. 2 illustrates an example of co-editing in a multiple device environment, in the related art;

FIG. 3 illustrates an example of a user input related to co-editing, according to one or more embodiments;

FIG. 4 is a flowchart illustrating an example of a method for real-time co-editing, according to one or more embodiments;

FIG. 5A illustrates an example of separation and generation of a user input related to real-time co-editing, according to one or more embodiments;

FIG. 5B illustrates an example of transmission of a user input related to real-time co-editing, according to one or more embodiments;

FIGS. 6A to 6D illustrate an example of a representation of a user input related to real-time co-editing, according to one or more embodiments;

FIG. 7 is a flowchart illustrating an example of a method for displaying a user input according to a real-time co-editing method, according to one or more embodiments; and

FIG. 8 illustrates an example of real-time co-editing in a multiple device environment.

### DETAILED DESCRIPTION

Terms used in the present disclosure are used only to describe a specific embodiment, and may not be intended to limit scope of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In one or more embodiments of the present disclosure described below, a hardware approach will be described as an example. However, since one or more embodiments of the present disclosure include technology that uses both hardware and software, the one or more embodiments of the present disclosure do not exclude a software-based approach.

A term referring to a configuration of a device (e.g., a processor, a camera, a display, a module, a pen, a communication circuit, and the like), a term referring to a calculation state (e.g., a step, operation, a procedure), a term referring to a signal (e.g., a signal, information, data, a stream, a user input, an input, and the like), a term referring to data (e.g., a parameter, a value, and the like) used in the disclosure are exemplified. Therefore, the present disclosure is not limited to terms described below, and other terms having equivalent technical meanings may be used.

In addition, in the present disclosure, a term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ means at least one of elements from A (including A) to B (including B).

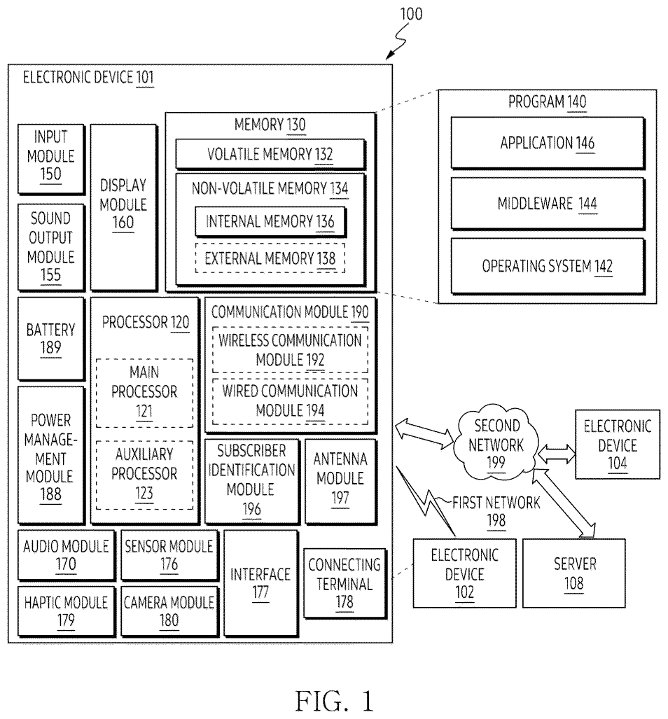

FIG. 1 is a block diagram of an electronic device in a network environment according to one or more embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through a wire or wires) or wirelessly coupled with the electronic device 101.

The sensor module 176 may detect operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through a wire or wires) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) between the at least some of the above-described components via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be of a same type as, or a different type, from the electronic device 101. According to an embodiment, all or some of operations to be executed at the electronic device 101 may be executed at one or more of the external electronic devices 102, 104, or 108. For example, if the electronic device 101 may perform a function or a service automatically, or in response to (or based on) a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

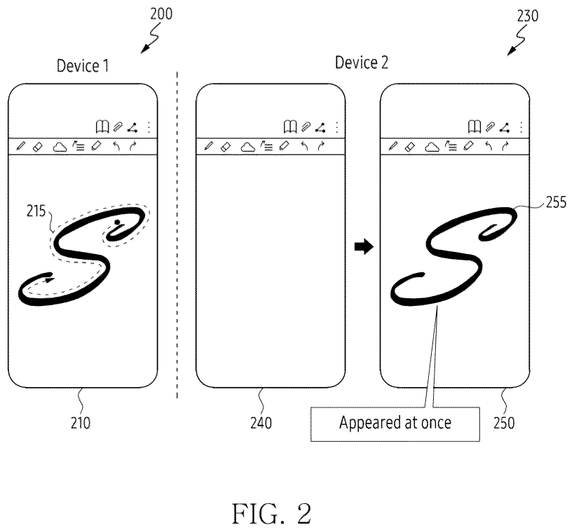

FIG. 2 illustrates an example of co-editing in a multiple device environment, in the related art.

A multiple device environment may be a network in which a plurality of electronic devices are connected via a server. Co-editing may be a function in which a plurality of users (or a plurality of electronic devices) may edit the same document at the same time, and edited content in a specific electronic device is expressed in other electronic devices.

In FIG. 2 that shows an embodiment in the related art, an object including inputs (a user input) by a user is described as an example of a stroke, but the present disclosure is not limited thereto. For example, the object may be an instruction including addition, modification, or deletion, and the like of data inputted by the user. In addition, the object may include a text, an image, a video, an audio input, and the like. The object may be a minimum unit distinguishable with respect to an input of the user. For example, in a case of the stroke, the object may be one character. In addition, in a case of the instruction, the object may be one instruction, such as addition, modification, or deletion, and the like of data.

FIG. 2 illustrates an example of performing co-editing in a multiple device environment including a first electronic device 200 and a second electronic device 230. Herein, a user input is inputted to the first electronic device 200. Herein, the user input may include hand-writing. For example, the user input may be directly inputted by a finger of the user, inputted by a pen or a pen-shaped electronic device, or inputted by a keyboard or a keypad, and the like. The user input inputted from the first electronic device 200 is delivered to the second electronic device 230, via a server, and then outputted via a display of the second electronic device 230.

In FIG. 2, an object 215, which is an S-shaped stroke, may be inputted by the user on a display 210 of the first electronic device 200. At this time, the object 215 may be consecutively inputted over time. For example, the input of the object 215 may start from a 1 o'clock direction and the input may be terminated at a 7 o'clock direction. At this time, at a time point when the object 215 is inputted to the first electronic device 200, a user of the second electronic device 230 may not check any change via the display 240. After a certain period of time, the second electronic device 230 may display contents 255 corresponding to the object 215 inputted by the user of the first electronic device 200 at once via the display 250, and the user of the second electronic device 230 may identify the content 255.

In other words, in the related art, even when the user of the first electronic device 200 consecutively writes the object 215 over time, the user of the second electronic device 230 may identify only the content 255 in which a completed result of the object 215 is displayed at once. The reason why only the content 255, which is the completed result, is displayed is because after the input of the object 215 is terminated, information for the object 215 is delivered to the second electronic device 230, by being converted into data by a specific rule (a promise or an algorithm), and only the content 255 corresponding to the object 215, which is the result of the input by the user, is generated in the second electronic device 230.

As described above, in the conventional co-editing technology in the related art, changes generated on a some device may be delivered to a server by a co-editing solution, and data may be organized by a specific algorithm and then transmitted to other devices. Thereafter, each device may configure the delivered data in a completed form based on a promised format, and the completed form may be expressed or displayed in each device. However, in the related art, the changes may be identified only as a specific unit (e.g., an object). The changes inputted in a device may be synchronized to a server after an input of a specific unit is completed, and after entire synchronized data is downloaded, contents corresponding to the entire data may be added via a display of each of the other devices without any significant effect.

Hereinafter, in the present disclosure, a device and a method for transmitting and expressing a user input for ‘real-time co-editing’ are provided. The real-time co-editing device and the method of the present disclosure may separate data of the user input, and then, transmit and express the separated data of the user input. In other words, the real-time co-editing device and method of the present disclosure may provide the user with an effect (a real-time effect) of expressing the user input inputted from some device to another device in real-time. Accordingly, the real-time co-editing device and method of the present disclosure may transmit some separated data even before the user input of the specific unit is completely added, compared to a co-editing method that may be delivered and displayed to another device only when the user input of the specific unit (e.g., an object) is completely added. In addition, the real-time co-editing device and method of the present disclosure may reproduce the same situation in which an actual user wrote the user input, thereby providing user experience of performing co-editing in real-time.

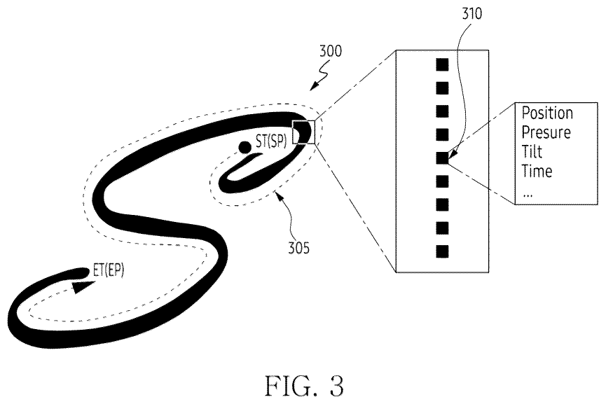

FIG. 3 illustrates an example of a user input related to co-editing.

Co-editing may be a function in which a plurality of users (or a plurality of electronic devices) may edit the same document at the same time, and edited content in a specific electronic device is expressed in other electronic devices. In FIG. 3, an object including inputs (a user input) by a user is described as an example of a stroke, but the present disclosure is not limited thereto. For example, the object may be an instruction including addition, modification, or deletion, and the like of data, inputted by the user. In addition, the object may include a text, an image, a video, an audio input, and the like. The object may be a minimum unit distinguishable with respect to an input of the user. For example, in a case of the stroke, the object may be one character. In addition, in a case of the instruction, the object may be one instruction, such as addition, modification, or deletion, and the like of data.

FIG. 3 illustrates an object 300, which is an S-shaped stroke, as an example. The object 300 may be inputted by the user on a display of an electronic device. At this time, the object 300 may be inputted by the user along an input path 305. For example, the input of the object 300 may start at a 1 o'clock direction and may be terminated at a 7 o'clock direction along the input path 305. As described above, the object 300 may be consecutively inputted over time. For example, an input of the object 300 by the user may start at a starting point (SP) in a starting time (ST). In addition, the input of the object 300 by the user may be terminated at an ending point (EP) in an ending time (ET). The object 300 may be inputted from a starting point in the 1 o'clock direction to an ending point in the 7 o'clock direction, and the object 300 may be inputted from a starting time to an ending time.

The object 300 may include a plurality of user inputs 310. For example, the user inputs 310 inputted by the user on the display of the electronic device may be configured with the S-shaped stroke, and the completed stroke may be the object 300. The object 300 may be defined as a combination of information for each of the user inputs 310. For example, information for the user input 310 configuring the object 300, which is a stroke, may include information for a position, information for pressure, information for a tilt, and information on time. The information for the position may include information for a relative position. For example, the information for the position may be a direction in which the current user input 310 is positioned compared to the previous user input 310. The information for the position may include at least one of an initial, a top, a bottom, a left, and a right. In addition, the information for the pressure may be pressure that presses the display in a perpendicular direction while the user input 310 is inputted. In addition, the information for the tilt may be an angle between a central axis to which the user input 310 is inputted and a direction perpendicular to the display. The information for the time may be time when the user input 310 is inputted. As described above, the object 300 may include the plurality of user inputs 310, and each of the plurality of user inputs 310 may be defined as information for the user input 310, so that the object 300 may be defined as a combination of information for the user input 310.

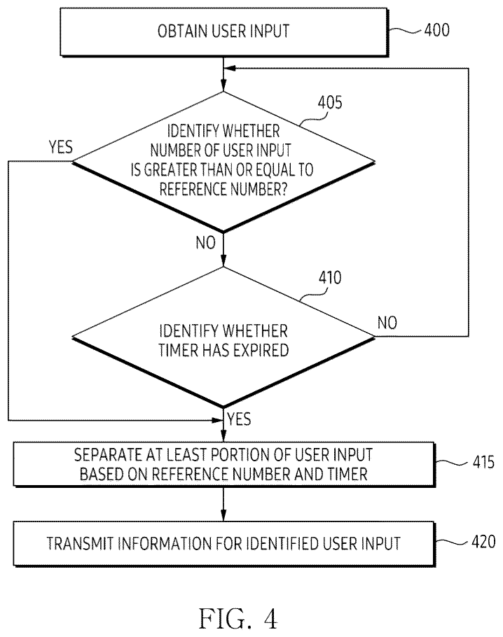

FIG. 4 is a flowchart illustrating an example of a method for real-time co-editing. A method according to the flowchart of FIG. 4 may be performed by the electronic device 101 of FIG. 1.

Co-editing may be a function in which a plurality of users (or a plurality of electronic devices) may edit the same document at the same time, and edited content in a specific electronic device is expressed in other electronic devices. In FIG. 4, an object including inputs (a user input) by a user is described as an example of a stroke, but the present disclosure is not limited thereto. For example, the object may be an instruction including addition, modification, or deletion, and the like of data, inputted by the user. In addition, the object may include a text input, an image input, a video input, an audio input, and the like. The object may be a minimum unit distinguishable with respect to an input of the user. For example, in a case of the stroke, the object may be one character. In addition, in a case of the instruction, the object may be one instruction, such as addition, modification, or deletion, and the like of data.

Referring to FIG. 4, in operation 400, an electronic device may obtain the user input. Herein, the electronic device may be a device to which the user input is inputted. According to an embodiment, in a case of obtaining an initial user input, the electronic device may start a timer related to the user input. Herein, the initial user input may refer to a user input obtained for first time after the user input for the electronic device does not exist during a certain period of time. The timer related to the user input may be a timer for measuring time during which the user input lasts. In an embodiment, the electronic device may execute an application for a real-time co-editing function. Accordingly, the electronic device may be connected to an external electronic device via a server. Herein, the external electronic device may be a device outputting contents corresponding to the user input inputted to the electronic device.

In operation 405, the electronic device may identify whether the number of user inputs received while the timer is activated is greater than or equal to a reference number. Herein, the activation of the timer may be a state that the timer has not expired, stopped, or reset after the timer started. According to an embodiment, the electronic device may identify whether the number of user input inputted by the user is greater than or equal to the reference number, in order to separate and transmit the user input. The reference number, which is a threshold for the number of user input, may be predetermined. Alternatively, the reference number may be determined based on an environment of a network related to the electronic device, the external electronic device, and the server. For example, the reference number may be determined based on a data rate of the network. For example, the reference number may be set to a default as a predetermined value. After being set to the default, the reference number may be increased or decreased according to the network environment. In case that the data rate of the network is greater than or equal to certain speed, the reference number may be increased, and in a case that the data rate of the network is less than or equal to the certain speed, the reference number may be decreased. However, an embodiment of the present disclosure is not limited thereto. The electronic device may adjust the reference number according to the network environment. For example, in a case that the data rate of the network is greater than or equal to the certain speed, the reference number may be maintained.

In operation 405, in a case of identifying that the number of user inputs is greater than or equal to the reference number, the electronic device may perform operation 415. In an example embodiment of identifying that the number of user inputs is greater than or equal to the reference number, the electronic device may reset the timer. On the other hand, in operation 405, in a case of identifying that user inputs are less than the reference number, the electronic device may perform operation 410.

In operation 410, the electronic device may identify whether the timer has expired. Herein, the expiration of the timer may be that a time interval (or a length of the timer) for maintaining activation of the timer has terminated. According to an embodiment, the electronic device may identify whether the timer expires in order to separate and transmit user inputs. The time interval for maintaining the activation of the timer is time during which the timer is maintained, and may be determined in advance. Alternatively, the time interval for maintaining the activation of the timer may be determined based on the environment of the network related to the electronic device, the external electronic device, and the server. For example, the time interval for maintaining the activation of the timer may be determined based on the data rate of the network. For example, the time interval for maintaining the activation of the timer may be set to a default as the predetermined value. After being set to the default, the time interval for maintaining the activation of the timer may be maintained or decreased according to the network environment. In case that the data rate of the network is greater than or equal to the certain speed, the time interval for maintaining the activation of the timer may be maintained, and in a case that the data rate of the network is less than or equal to the certain speed, the time interval for maintaining the activation of the timer may be decreased. However, an embodiment of the present disclosure is not limited thereto. The electronic device may adjust the time interval for maintaining the activation of the timer according to the network environment. For example, in a case that the data rate of the network is greater than or equal to the certain speed, the time interval for maintaining the activation of the timer may be increased.

In operation 410, in a case of identifying that the timer has expired, the electronic device may perform operation 415. On the other hand, in operation 410, in a case of identifying that the timer has not expired, the electronic device may return to operation 405 and then perform operation 405. In an example embodiment of identifying that the timer has expired in operation 410, the electronic device may reset the timer.

In operation 415, the electronic device may separate at least a portion of the user inputs based on the reference number and the timer. For example, in a case of identifying that the number of user inputs reaches (i.e., the same) the reference number before the timer is expired, the electronic device may identify the same number of user inputs as the reference number. The identified user inputs may be separated into a data state. Herein, being separated into the data state may be obtaining and storing information for each of the identified user inputs. In addition, in a case of identifying that the timer has expired, the electronic device may identify user inputs as many as the number of the user inputs inputted until a time point the timer has expired. The identified user inputs may be separated into a data state. The information for the user input may include at least one of information for a position, information for pressure, information for a tilt, or information for time. The information for the position may include information for a relative position. For example, it may be a direction in which a current user input is positioned compared to a previous user input. The information for the position may include at least one of an initial, a top, a bottom, a left, and a right. In addition, the information for the pressure may be pressure that presses a display in a perpendicular direction while the user input is inputted. In addition, the information for the tilt may be an angle between a central axis to which the user input is inputted and a direction perpendicular to the display. The information for the time may be time when the user input is inputted. In FIG. 4, an object that is a stroke is described as an example, and information for the user input includes information for the position, the pressure, the tilt, or the time, but the present disclosure is not limited thereto. For example, in a case that the user input is an instruction, such as addition, modification, or deletion of data, it may include information for the instruction, an order in which the instruction is inputted, a priority between the instructions, or information for the time when the instruction is inputted, and the like.

In operation 420, the electronic device may transmit information for the identified user inputs to the external electronic device. According to an embodiment, the electronic device may transmit information for the user inputs identified in operation 415 to the external electronic device via the server. Contents corresponding to the transmitted information may be outputted (or displayed) via a display of the external electronic device. The content may include a configuration corresponding to the user input inputted from the electronic device.

In an embodiment, after the timer is reset, the electronic device may return to operation 400 and perform operation 400 again. In other words, the electronic device may identify whether the user input is obtained. Accordingly, as described in operation 400, the electronic device may obtain (or identify acquisition) the user input and may restart the timer. A user input inputted initially after the timer is reset may be referred to as an initial user input. That is, each of the user input obtained after not being input for more than or equal to a certain period of time or the user input inputted initially after the timer is reset may be referred to as the initial user input.

According to an embodiment, the electronic device may transmit information for the identified user input to the external electronic device in a stacked form. For example, assumed that there are a first set of user inputs and a second set of user inputs that are inputted after the first set of user inputs. The electronic device may identify the first set of user inputs based on identifying that the timer has expired or that it is greater than or equal to the reference number before the timer is expired. The electronic device may obtain first information for the first set of user inputs and transmit the first information to the external electronic device. Thereafter, a first electronic device may identify the second set of user inputs by identifying that the reset and restarted timer has expired or is greater than or equal to the reference number before the timer is expired. The first electronic device may obtain second information for the second set of user inputs. However, the first electronic device may transmit the first information and the second information to the external electronic device together, other than transmitting only the second information to the external electronic device. This may be for outputting a real-time co-editing situation from the external electronic device. In case that only the second information is transmitted without the first information already transmitted in a previous step, the external electronic device may have difficulty consecutively outputting contents corresponding to the second set of user inputs. Therefore, the first electronic device may transmit the first information and the second information to the external electronic device together, and the external electronic device may consecutively output the contents corresponding to the second set of user inputs to contents corresponding to the first set of user inputs.

A specific example of the real-time co-editing situation as described above is as follows. It is assumed that the reference number is 100 and the time interval (or a length of the timer) for maintaining activation of the timer is 1 second, in a situation in which the electronic device accumulates information for the user inputs and then transmits the information to the external electronic device. When the time when the user input starts is TO, the timer may be started (or activated) when the initial user input is inputted. In case that the user inputs are inputted one-hundred (100) times, until a time point T1 when 0.5 seconds have elapsed after the timer started, one-hundred (100) user inputs may be separated, and information for one-hundred (100) user inputs may be transmitted to the external electronic device. At this time, the timer may be reset.

In a case of a time point T2 when 1.5 seconds have elapsed after TO, the reset timer may be restarted when the user input is inputted after T1. In a situation where a user input is inputted 50 times during a period of 1 second from T1 to T2, since a length of the timer is 1 second, the timer may expire at T2. 150 user inputs inputted until moment of expiration may be separated. Information for 150 user inputs may be transmitted to the external electronic device. At this time, the timer may be reset again.

In the case of a time point T3 when 2.5 seconds have elapsed after TO, the reset timer may be restarted when the user input is inputted after T2. In a situation where the user input is inputted 20 times during a period of 1 second from T2 to T3, after a length of the timer is 1 second, the timer may expire at T3. 170 user inputs inputted until moment of expiration may be separated. Information for 170 user inputs may be transmitted to the external electronic device. At this time, the timer may be reset again.

In the case of a time point T4 when 3 seconds have elapsed after TO, the reset timer may be restarted when the user input is inputted after T3. In case that the user input is inputted one-hundred (100) times from T3 to T4, in which 0.5 seconds has elapsed after T3, 270 user inputs may be separated. Information for 270 user inputs may be transmitted to the external electronic device. At this time, the timer may be reset.

At a time point T5 when writing of the user is completed, in a case that the user input is inputted 30 times from T4 to T5, 300 user inputs may be separated. Information for 300 user inputs may be transmitted to the external electronic device. At this time, the timer may be reset.

In the above-described example, transmission of information for accumulated user inputs by the electronic device to the external electronic device may be configured in various ways. For example, when information transmitted initially by the electronic device is referred to as first information, next information is referred to as second information, and last information transmitted is referred to as third information, the electronic device may transmit the first information, the first information and the second information, and the first information to the third information to the external electronic device at each time point. Alternatively, the electronic device may transmit the first information, fourth information, and fifth information to the external electronic device. Herein, the fourth information may be one information that combines the first information and the second information, and the fifth information may be one information that combines the first information to the third information. In other words, in transmitting information for accumulated user inputs to the external electronic device, the electronic device may transmit information configured through various methods.

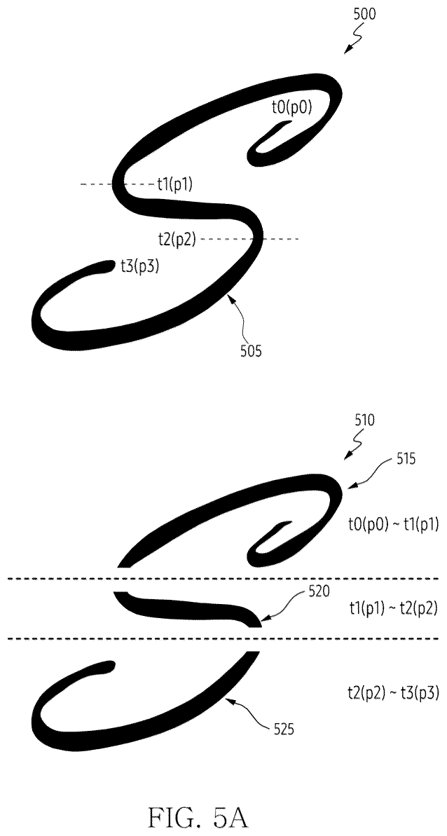

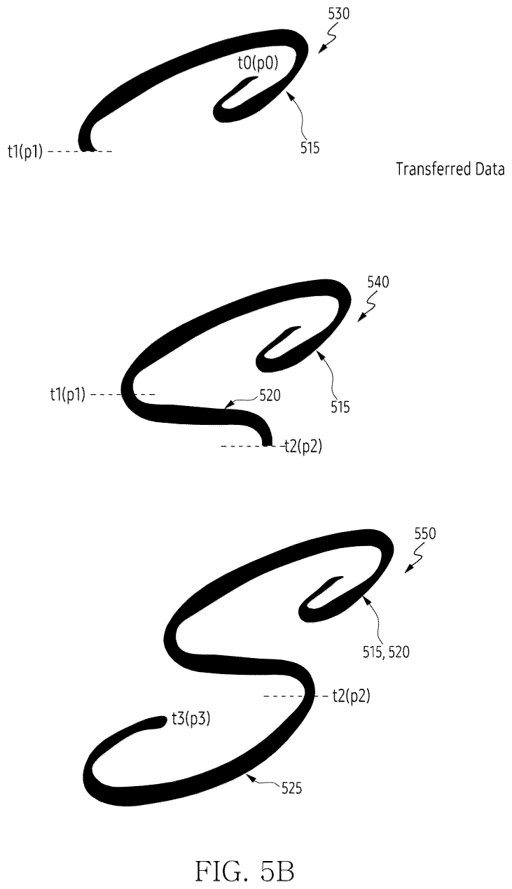

FIG. 5A illustrates an example of separation and generation of a user input related to real-time co-editing. FIG. 5B illustrates an example of transmission of a user input related to real-time co-editing.

Co-editing may be a function in which a plurality of users (or a plurality of electronic devices) may edit the same document at the same time, and edited content in a specific electronic device is expressed in other electronic devices. In FIGS. 5A and 5B, an object including inputs (a user input) by a user is described as an example of a stroke, but the present disclosure is not limited thereto. For example, the object may be an instruction including addition, modification, or deletion, and the like of data, inputted by the user. In addition, the object may include a text input, an image input, a video input, an audio input, and the like. The object may be a minimum unit distinguishable with respect to an input of the user. For example, in a case of the stroke, the object may be one character. In addition, in a case of the instruction, the object may be one instruction, such as addition, modification, or deletion, and the like of data.

FIGS. 5A and 5B illustrate an example of separating user inputs for real-time co-editing according to embodiments of the present disclosure, generating information for the user inputs, and transmitting the information to another external electronic device.

Referring to FIG. 5A, in a first example 500, an object 505 may be inputted on a display of an electronic device by the user. For example, the object 505 may be an S-shaped stroke. The input of the object 505 by the user may start at a 1 o'clock direction and may be terminated at a 7 o'clock direction. The object 505 may be consecutively inputted according to passage of time. For example, an input of the object 505 may start at position p0 at time to. In addition, the object 505 may be inputted to pass through at a position p1 at time t1 and at a position p2 at time t2, and an input may be terminated at a position p3 at time t3. In a second example 510, the object 505 may be configured with a plurality of sets 515, 520 and 525. For example, the object 505 may include a first set 515 including user inputs, a second set 520 including user inputs, and a third set 525 including user inputs. At this time, the first set 515 may include user inputs between t0 to t1. The second set 520 may include user inputs between t1 to t2. The third set 525 may include user inputs between t2 to t3.

Referring to FIG. 5B, in a third example 530 to a fifth example 550, the electronic device may transmit the separated object 505 to an external electronic device. Herein, the third example 530 to the fifth example 550 may be distinguished over time. In the third example 530, the electronic device may transmit only the first set 515 of user inputs to the external electronic device. Thereafter, in a fourth example 540, the electronic device may transmit the first set 515 of user inputs and the second set 520 of user inputs. Finally, in the fifth example 550, the electronic device may transmit the first set 515 of user inputs, the second set 520 of user inputs, and the third set 525 of user inputs. Herein, transmitting the first set 515, the second set 520, and the third set 525 of user inputs may be or correspond to transmitting ‘information’ for the first set 515, the second set 520, and the third set 525 of user inputs. As described above, the electronic device may transmit information for user inputs configuring the object 505 over time. Accordingly, even before the object 505 is completed, the electronic device may transmit information for user inputs to the external electronic device, and the external electronic device may check changes that are edited in real-time in the electronic device. Real-time co-editing device and method of the present disclosure may provide a user with an effect (a real-time effect) of expressing a user input inputted in the electronic device to the external electronic device in real-time. The real-time co-editing device and method of the present disclosure may transmit some separated data (e.g., the first set 515, the first set 515 and the second set 520, or the first set 515 to the third set 525) even before the user input of a specific unit is completely added, compared to a co-editing method that may be delivered and displayed to another device only when the user input of the specific unit (e.g., an object) is completely added. In addition, the real-time co-editing device and the method of the present disclosure may reproduce the same situation in which an actual user wrote the user input, thereby providing user experience of performing co-editing in real-time.

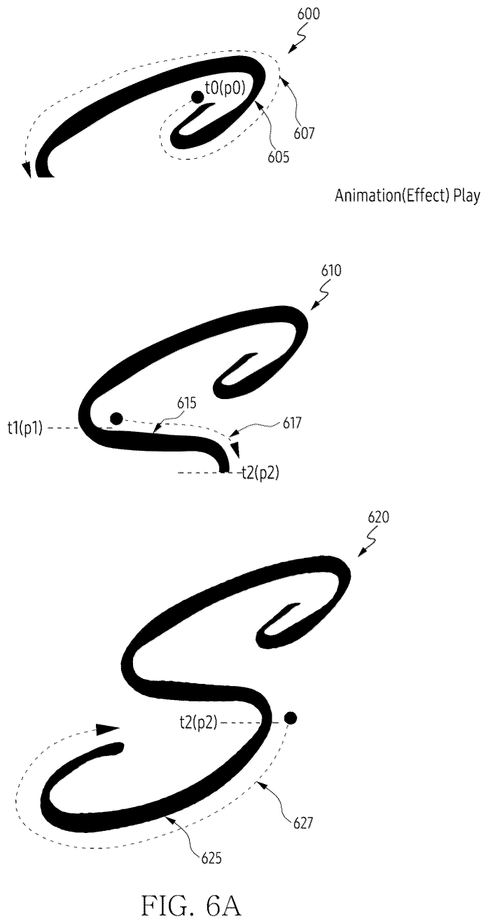

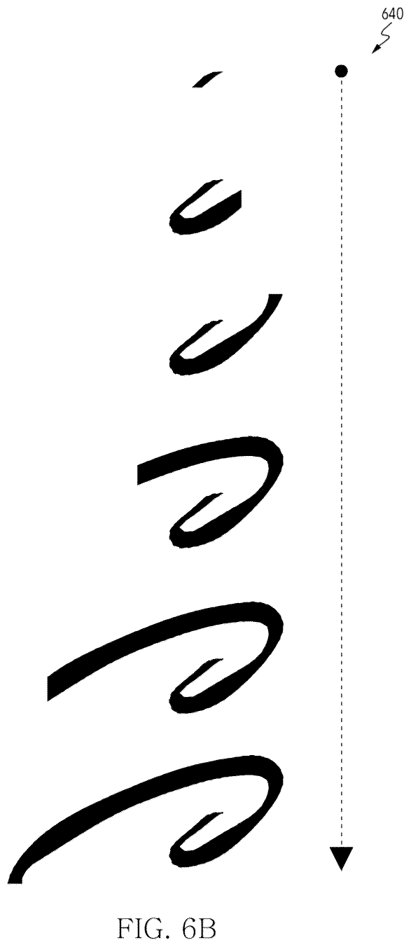

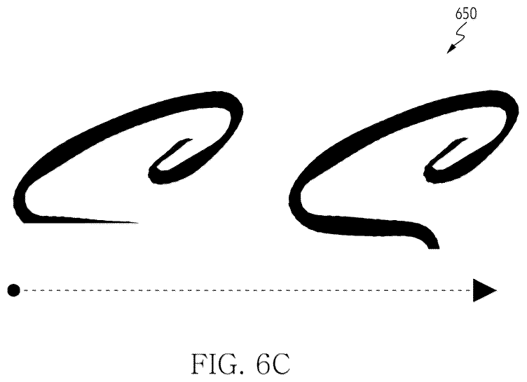

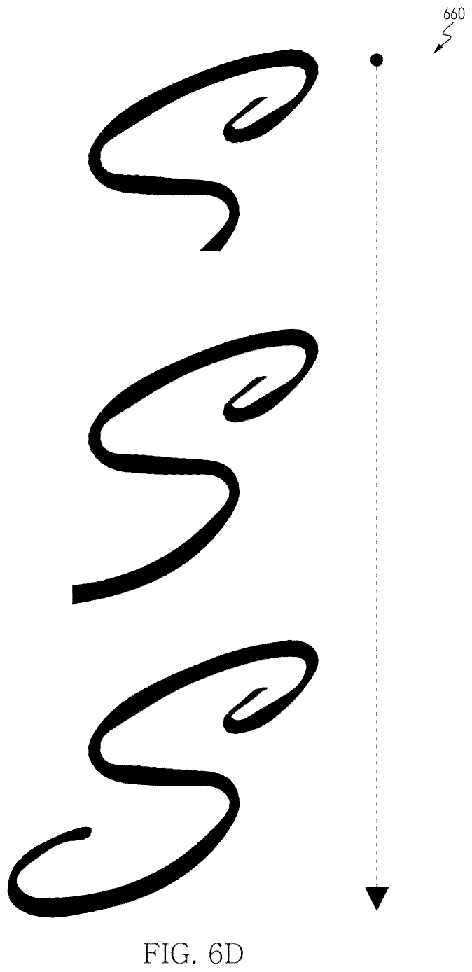

FIGS. 6A to 6D illustrate an example of a representation of a user input related to real-time co-editing. An electronic device of FIGS. 6A to 6D may be or correspond to the external electronic device of FIGS. 4, 5A, and 5B. In other words, the electronic device of FIGS. 6A to 6D may be an electronic device that receives information for user inputs and displays edited content via a display.

Co-editing may be a function in which a plurality of users (or a plurality of electronic devices) may edit the same document at the same time, and edited content in a specific electronic device is expressed in other electronic devices. In FIGS. 5A and 5B, an object including inputs (a user input) by a user is described as an example of a stroke, but the present disclosure is not limited thereto. For example, the object may be an instruction including addition, modification, or deletion, and the like of data, inputted by the user. In addition, the object may include a text input, an image input, a video input, an audio input, and the like. The object may be a minimum unit distinguishable with respect to an input of the user. For example, in a case of the stroke, the object may be one character. In addition, in a case of the instruction, the object may be one instruction, such as addition, modification, or deletion, and the like of data.

Referring to FIG. 6A, in a first example 600, the electronic device may receive first information for a first set 605 of user inputs. The electronic device may obtain first contents corresponding to the first set 605 of user inputs based on the first information. The obtained first contents may be visually displayed along a first path 607 via the display of the electronic device. In a second example 610, the electronic device may receive the first information and second information for a second set 615 of user inputs. The electronic device may obtain second contents corresponding to the second set 615 of user inputs based on the first information and the second information. The obtained second contents may be visually displayed along a second path 617 via the display of the electronic device consecutively on the displayed first contents. In a third example 620, the electronic device may receive the first information, the second information, and third information for a third set 625 of user inputs. The electronic device may obtain third contents corresponding to the third set 625 of user inputs based on the first information to the third information. The obtained third contents may be visually displayed along a third path 627 via the display of the electronic device consecutively on the displayed the first contents and the second contents.

Referring to FIG. 6B, a fourth example 640 illustrates a process in which the first contents obtained based on the first information for the first set 605 of user inputs is displayed. The first contents may refer to data corresponding to the first set 605 of user inputs. The first contents may be displayed in an order (or an path) inputted by the user in the external electronic device.

Referring to FIG. 6C, a fifth example 650 illustrates a process in which the second contents obtained based on the second information for the second set 615 of user inputs is displayed. The second contents may refer to data corresponding to the second set 615 of user inputs. The second contents may be consecutively displayed on the already displayed first contents. In other words, the second contents may be displayed extending from a point where a display of the first contents is terminated. The second contents may be displayed in an order (or a path) inputted by the user in the external electronic device.

Referring to FIG. 6D, a sixth example 660 illustrates a process in which the third contents obtained based on the third information for the third set 625 of user inputs is displayed. The third contents may refer to data corresponding to the third set 625 of user inputs. The third contents may be consecutively displayed in the already displayed first contents and the second contents. In other words, the third contents may be displayed extending from a point where a display of the second contents is terminated. The third contents may be displayed in an order (or a path) inputted by the user in the external electronic device.

As described above, the electronic device may visually display contents by restoring an object to original form as inputted from the external electronic device in which the object is actually generated based on information for the received user inputs. Herein, the contents may refer to an object or data corresponding to a portion (user inputs) of the object. The electronic device may reproduce a portion of the object based on the information for the received user inputs even before the object by a user input is completed in the external electronic device. Accordingly, the electronic device may display an edited matter in real-time in the external electronic device, and the user of the electronic device may experience a real-time effect.

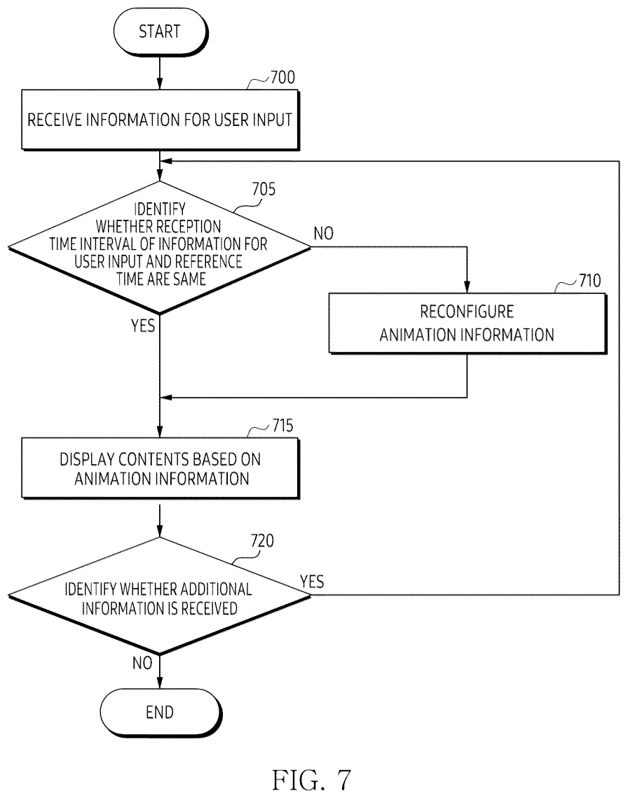

FIG. 7 is a flowchart illustrating an example of a method for displaying a user input according to a real-time co-editing method. An electronic device of FIG. 7 may be or correspond to the external electronic device of FIG. 4 and the external electronic device of FIGS. 5A and 5B. In other words, the electronic device of FIG. 7 may be an electronic device that receives information for user inputs and displays edited content via a display.

A multiple device environment may be a network in which a plurality of electronic devices are connected via a server. Co-editing may be a function in which a plurality of users (or a plurality of electronic devices) may edit the same document at the same time, and edited content in a specific electronic device is expressed in other electronic devices. In FIG. 7, an object including inputs (a user input) by a user is described as an example of a stroke, but the present disclosure is not limited thereto. For example, the object may be an instruction including addition, modification, or deletion, and the like of data, inputted by the user. In addition, the object may include a text input, an image input, a video input, an audio input, and the like. The object may be a minimum unit distinguishable with respect to an input of the user. For example, in a case of the stroke, the object may be one character. In addition, in a case of the instruction, the object may be one instruction, such as addition, modification, or deletion, and the like of data.

Although not illustrated in FIG. 7, before operation 700, the electronic device may execute an application for a real-time co-editing function. Accordingly, the electronic device may be connected to the external electronic device via a server. Herein, the electronic device may be a device outputting contents corresponding to a user input inputted to the external electronic device.

Referring to FIG. 7, in operation 700, the electronic device may receive information for the user input from the external electronic device. According to an embodiment, the electronic device may receive information for user inputs from the external electronic device via the server. Contents corresponding to the received information may be outputted (or displayed) via the display of the electronic device. The contents may include a configuration corresponding to the user input inputted in the external electronic device. According to an embodiment, the information for the user input may include at least one of information for a position, information for pressure, information for a tilt, or information for time. The information about the position may include information about a relative position. For example, it may be a direction in which a current user input is positioned compared to a previous user input. The information for the position may include at least one of an initial, a top, a bottom, a left, and a right. The information for the pressure may be pressure that presses a display in a perpendicular direction while the user input is inputted. In addition, the information for the tilt may be an angle between a central axis to which the user input is inputted and a direction perpendicular to the display. The information for the time may be time when the user input is inputted. In FIG. 7, an object that is a stroke is described as an example, and information for the user input includes information for the position, the pressure, the tilt, or the time, but the present disclosure is not limited thereto. For example, in a case that the user input is an instruction, such as addition, modification, or deletion of data, it may include information for the instruction, an order in which the instruction is inputted, a priority between the instructions, or information for the time when the instruction is inputted, and the like.

In operation 705, the electronic device may identify whether a reception time interval and reference time of the information for the user input are the same. Herein, the reception time interval of the information for the user input may be difference between time when previous information is received and time when current information is received. In addition, in a case that the information for the user input is initially received, the reception time interval of the information for the user input may be difference between a time point when the input started in the external electronic device and time when the current information is received. The electronic device may receive a notification that an input has started in the external electronic device and information for start time via the server. The reference time may be predetermined as a threshold for the reception time interval of the information for the user input. Alternatively, the reference time may be determined based on an environment of a network including the electronic device, the external electronic device, and the server. For example, the reference time may be determined based on a data rate of the network. For example, the reference time may be set to a default as a predetermined value. After being set to the default, the reference time may be changed according to the network environment.

In operation 705, in a case of identifying that the reception time interval and the reference time are the same, the electronic device may perform operation 715. In operation 705, in a case of identifying that the reception time interval and the reference time are not the same, the electronic device may perform operation 710.

According to an embodiment, in operation 710, the electronic device may reconfigure animation information. Herein, the animation information may be information for visually expressing contents corresponding to received information. For example, the animation information may include start time when the contents is expressed, time interval when the contents is expressed, speed at which the contents is expressed, a size at which the contents is expressed, and additional information for changes of the contents. The animation information may be referred to as visualization effect information.

In case that the reception time interval and the reference time are different from each other, the electronic device may change the animation information to correspond to the reception time interval. For example, assume that the reference time is 1 second and a time point at which a user starts inputting from the external electronic device is T0. In case that first information for user inputs is received at a time point T1 after 2 seconds have elapsed after T0, first contents corresponding to the first information needs to be expressed for 2 seconds. Therefore, the animation information for the first contents may be reconfigured to 2 seconds. In case that second information for user inputs is received at a time point T2 after 3 seconds have elapsed after T1, the second contents corresponding to the second information needs to be expressed for 3 seconds. Therefore, the animation information for the second contents may be reconfigured to 3 seconds. In case that third information for user inputs is received at a time point T3 after 0.5 seconds have elapsed after T2, the third contents corresponding to the third information needs to be expressed for 0.5 seconds. Therefore, the animation information for the third contents may be reconfigured to 0.5 seconds.

In operation 715, the electronic device may display contents via the display based on the animation information. For example, the electronic device may obtain contents corresponding to received information based on a default or reconfigured the animation information, and may display the contents via the display. A specific example of a method of display contents by the electronic device may be substantially the same as FIGS. 6A to 6D.

According to an embodiment, the electronic device may configure an animation based on the set animation information. Herein, configuring the animation may be matching the animation information and the contents. For example, at the time point T2, the electronic device may reconfigured the animation information to 3 seconds and set the reconfigured animation information to corresponding contents. Alternatively, in a case that the reception time interval is 1 second, which is the same as the reference time, the electronic device may set the animation information of 1 second, which is a default, to the corresponding content. The electronic device may set an animation and display contents based on the set animation.

In operation 720, the electronic device may identify whether additional information is received. The electronic device may identify whether the additional information for the user input is received from the external electronic device. Herein, the additional information may include the information for the user input next to the user input related to the information received in operation 700. In operation 720, in a case that the additional information for the user input is received, the electronic device may return to the step 705 and then identify whether the reception time interval and the reference time between the received information and previously received information are the same. In case that the additional information for the user input is not received, the electronic device may not perform operation of displaying contents based on the received information. That is, the electronic device may terminate displaying the contents. Herein, a case that the additional information for the user input is not received may include a case that the user does not input to the external electronic device or a connection between the electronic device and the server (or the external electronic device and the server) is lost, and a state in which the electronic device may not receive information from the server (e.g., a power off state of the electronic device, an emergency situation, and the like).

As described above, the electronic device may receive the information for the user input inputted to the external electronic device, and display contents obtained based on the received information according to a network environment or a performance of the electronic device. For example, in a case that the electronic device receives the information from the external electronic device later than the reference time, the electronic device may express contents more slowly as it is delayed compared to the reference time. Accordingly, the user of the electronic device may experience a more natural real-time co-editing function.

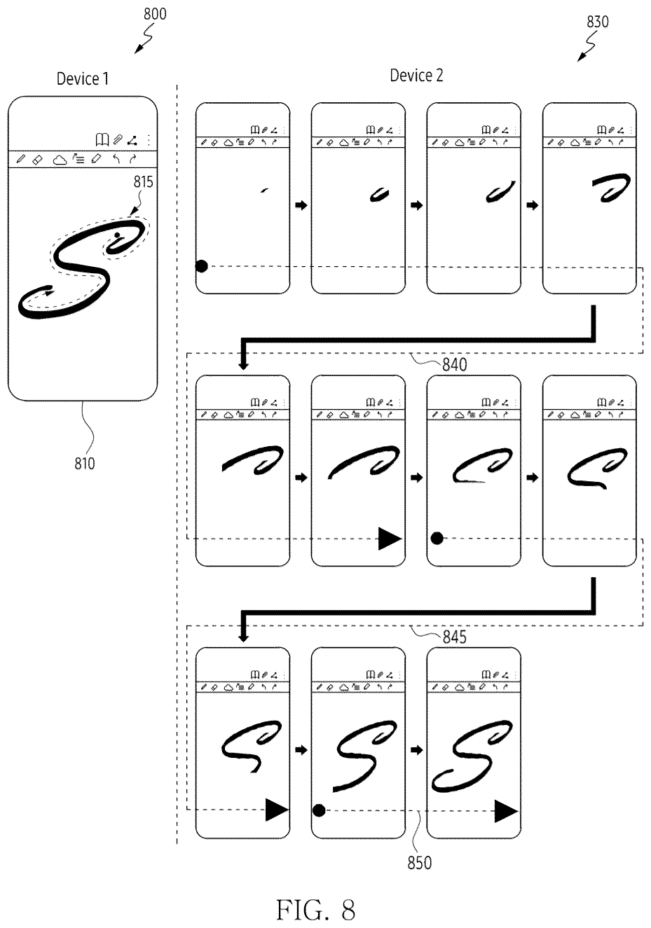

FIG. 8 illustrates an example of real-time co-editing in a multiple device environment.

A multiple device environment may be a network in which a plurality of electronic devices are connected via a server. Co-editing may be a function in which a plurality of users (or a plurality of electronic devices) may edit the same document at the same time, and edited content in a specific electronic device is expressed in other electronic devices. In FIG. 8, an object including inputs (a user input) by a user is described as an example of a stroke, but the present disclosure is not limited thereto. For example, the object may be an instruction including addition, modification, or deletion, and the like of data inputted by the user. In addition, the object may include a text input, an image input, a video input, an audio input, and the like. The object may be a minimum unit distinguishable with respect to an input of the user. For example, in a case of the stroke, the object may be one character. In addition, in a case of the instruction, the object may be one instruction, such as addition, modification, or deletion, and the like of data.

FIG. 8 illustrates an example of performing co-editing in a multiple device environment including a first electronic device 800 and a second electronic device 830. Herein, the first electronic device 800 may be a device to which a user input is inputted. Herein, the user input may include hand-writing. For example, the user input may be a signal that is directly inputted by a finger of a user, inputted by a pen or a pen-shaped electronic device, or inputted by a keyboard or a keypad, and the like. The second electronic device 230 may be a device in which the user input inputted from the first electronic device 200 is delivered via a server and then outputted via a display.

An object 815, which is an S-shaped stroke, may be inputted by a user on a display 810 of the first electronic device 800. The object 815 may be consecutively inputted over time. For example, the object 815 may start to be inputted from a 1 o'clock direction and the input may be terminated at a 7 o'clock direction. While the object 815 is inputted to the first electronic device 800, the user of the second electronic device 830 may check contents corresponding to a portion or all of the object 815 by receiving information for a user input of the object 815. For example, contents corresponding to a portion or all of the object 815 may be displayed via a display of the second electronic device 830 across a first example 840, a second example 845, and a third example 850 over time. Accordingly, the user of the second electronic device 830 may check the edited matter by the user of the first electronic device 800 in real-time.

in general co-editing technology, changes generated on a some device may be delivered to a server by a co-editing solution, and data may be organized by a specific algorithm and then transmitted to other devices. At this time, the delivered data may be related to currently used co-editing. Thereafter, each device may configure the delivered data in a completed form based on a promised format, and the completed form may be expressed or displayed in each device. However, the changes may be identified only as a specific unit (e.g., an object). The changes inputted in a device may be synchronized to a server after an input of a specific unit is completed, and after entire synchronized data is downloaded, contents corresponding to the entire data may be added via a display of each of the other devices without any significant effect.

Alternatively, referring to FIGS. 1 to 8, a real-time co-editing device and method of the present disclosure may separate data of the user input, and then transmit and express it. In other words, the real-time co-editing device and the method of the present disclosure may provide the user with an effect (a real-time effect) of expressing the user input inputted from some device to another device in real-time. Accordingly, the real-time co-editing device and the method of the present disclosure may transmit some separated data even before the user input of the specific unit is completely added, compared to a co-editing method that may be delivered and displayed to another device only when the user input of the specific unit (e.g., an object) is completely added. In addition, the real-time co-editing device and the method of the present disclosure may reproduce the same situation in which an actual user wrote the user input, thereby providing user experience of performing co-editing in real-time.

In FIGS. 1 to 8, an object that is a stroke is described as an example. In a case of stroke (or handwriting), a user may write the stroke or the handwriting using a body (e.g., a finger) or another device (e.g., a pen). In general, the object is identified based on operation of the user of detaching the body or another device from the electronic device and identified as another external electronic device, but the real-time co-editing device and method of the present disclosure may transmit information for a portion or all of the object even before detaching the finger or the pen from the electronic device. The external electronic device that receives this may display a matter to be edited in real time, and the user of the external electronic device may check this.

In a case of adding, modifying, or deleting a file, the real-time co-editing device and method of the present disclosure may improve usability and simultaneity of the user of the electronic device. For example, when the user of the electronic device performs operation of adding, modifying, or deleting file data such as an image and an audio, and the like, the external electronic device receiving information on this may pre-express operation of the file data and notify the user of the external electronic device. Accordingly, it may improve the usability and the simultaneity of the real-time co-editing to users.

In a case of text, even before the user of the electronic device completes writing of the text, the electronic device may transmit information for writing process to the external electronic device. Accordingly, the external electronic device may display contents for the writing process, and the user of the external electronic device may check the writing process over time.

In addition to the above-described the stroke, the file, and the text, the electronic device may transmit information to the external electronic device connected to the electronic device with respect to detachable objects. Accordingly, the user of the external electronic device may check changes caused by the user of the electronic device in real time. Therefore, the real-time co-editing device and the method of the present disclosure may reproduce the same situation in which the actual user wrote the user input, thereby effectively providing user experience of performing co-editing in real-time.

As described above, an electronic device 101 may comprise a display module 160. The electronic device 101 may comprise communication module 190. The electronic device 101 may comprise at least one processor 120 operatively coupled with the display module 160 and the communication module 190. The at least one processor 120 may be configured to identify (405) whether a number of a first set of user inputs received while a timer is activated reaches a reference number. The at least one processor 120 may be configured to, in response to (or based on) identifying (410) that the number of the first set of user inputs reaches the reference number before the timer is expired or identifying that the timer is expired, reset the timer and transmit (420), to an external electronic device, first information representing the first set of user inputs. The at least one processor 120 may be configured to identify (405) whether a number of a second set of user inputs received while the reset timer is activated reaches the reference number. The at least one processor 120 may be configured to, in response to (or based on) identifying (410) that the number of the second set of user inputs reaches the reference number before the reset timer is expired or identifying that the reset timer is expired, transmit (420), to the external electronic device, the first information and second information representing the second set of user inputs with respect to the first set of user inputs.

According to an embodiment, the at least one processor 120 may be configured to activate (400) the timer in a case of identifying obtaining the first set of user inputs.

According to an embodiment, first contents corresponding to the first set of user inputs may be displayed via a display of the external electronic device at first time based on the first information. Second contents corresponding to the first set of user inputs and the second set of user inputs may be displayed via the display of the external electronic device at second time after the first time based on the first information and the second information.

According to an embodiment, the first information may include at least one of position information, pressure information, tilt information, or time information for the first set of user inputs. The second information may include at least one of position information, pressure information, tilt information, or time information for the second set of user inputs.

As described above, a method performed by an electronic device 101 may comprise identifying (405) whether a number of a first set of user inputs received while a timer is activated reaches a reference number. The method may comprise, in response to (or based on) identifying (410) that the number of the first set of user inputs reaches the reference number before the timer is expired or identifying that the timer is expired, resetting the timer and transmitting (420), to an external electronic device, first information representing the first set of user inputs. The method may comprise identifying (405) whether a number of a second set of user inputs received while the reset timer is activated reaches the reference number. The method may comprise, in response to (or based on) identifying (410) that the number of the second set of user inputs reaches the reference number before the reset timer is expired or identifying that the reset timer is expired, transmitting (420), to the external electronic device, the first information and second information representing the second set of user inputs with respect to the first set of user inputs.

According to an embodiment, the method may comprise activating (400) the timer in a case of identifying obtaining the first set of user inputs.

According to an embodiment, reference time related to a length of the timer and the reference number may be identified based on a data rate of a network related to the electronic device and the external electronic device.

According to an embodiment, first contents corresponding to the first set of user inputs may be displayed via a display of the external electronic device at first time based on the first information. Second contents corresponding to the first set of user inputs and the second set of user inputs may be displayed via the display of the external electronic device at second time after the first time based on the first information and the second information.

According to an embodiment, the first information may include at least one of position information, pressure information, tilt information, or time information for the first set of user inputs. The second information may include at least one of position information, pressure information, tilt information, or time information for the second set of user inputs.

As described above, an electronic device 101 may comprise a display module 160. The electronic device 101 may comprise communication module 190. The electronic device 101 may comprise at least one processor 120 operatively coupled with the display module 160 and the communication module 190. The at least one processor 120 may be configured to receive (700), from an external electronic device, first information representing a first set of user inputs of the external electronic device connected to the electronic device 101. The at least one processor 120 may be configured to receive (720 or 700), from the external electronic device, the first information and second information representing a second set of user inputs with respect to the first set of user inputs. The at least one processor 120 may be configured to display (715), via the display module 160, first contents corresponding to the first set of user inputs based on the first information. The at least one processor 120 may be configured to display (715), via the display module 160, second contents corresponding to the first set of user inputs and the second set of user inputs based on the first information and the second information.

According to an embodiment, the at least one processor 120 may be configured to consecutively display the second contents with respect to the first contents based on the first information and the second information.

According to an embodiment, the first information may include at least one of position information, pressure information, tilt information, or time information for the first set of user inputs. The second information may include at least one of position information, pressure information, tilt information, or time information for the second set of user inputs.

According to an embodiment, the at least one processor 120 may be configured to identify (705) whether difference between first time when the first information is received and second time when the first information and the second information are received is equal to reference time. The at least one processor 120 may be configured to, in a case that the difference is equal to the reference time, configure an animation for displaying the second contents during the reference time. The at least one processor 120 may be configured to, in a case that the difference is not equal to the reference time, configure (710) an animation for displaying the second contents during time corresponding to the difference. The at least one processor 120 may be configured to display (715), via the display module 160, the second contents based on the configured animation.

According to an embodiment, the reference time is identified based on a data rate of a network between the electronic device 101 and the external electronic device or may be a predetermined value.

As described above, a method performed by an electronic device 101 may comprise receiving (700), from an external electronic device, first information representing a first set of user inputs of the external electronic device connected to the electronic device 101. The method may comprise receiving (720 or 700), from the external electronic device, the first information and second information representing a second set of user inputs with respect to the first set of user inputs. The method may comprise displaying (715), via the display module 160, first contents corresponding to the first set of user inputs based on the first information. The method may comprise displaying (715), via the display module 160, second contents corresponding to the first set of user inputs and the second set of user inputs based on the first information and the second information.

According to an embodiment, the method may comprise, consecutively displaying the second contents with respect to the first contents based on the first information and the second information.

According to an embodiment, the first information may include at least one of position information, pressure information, tilt information, or time information for the first set of user inputs. The second information may include at least one of position information, pressure information, tilt information, or time information for the second set of user inputs.

According to an embodiment, the method may comprise identifying (705) whether difference between first time when the first information is received and second time when the first information and the second information are received is equal to reference time. The method may comprise, in a case that the difference is equal to the reference time, configuring an animation for displaying the second contents during the reference time. The method may comprise, in a case that the difference is not equal to the reference time, configuring (710) an animation for displaying the second contents during time corresponding to the difference. The method may comprise displaying (720), via the display, the second contents based on the configured animation.

According to an embodiment, the reference time may be identified based on a data rate of a network between the electronic device and the external electronic device or may be a predetermined value.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

One or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. A singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively”, as “coupled with,” or “connected with” another element (e.g., a second element), it means that the element may be coupled with the other element directly (e.g., through a wire or wires), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of operations may be executed in a different order or omitted, or one or more other operations may be added.

What is claimed is:

1. An electronic device comprising:
a display; and
at least one processor operatively connected to the display and configured to:
identify whether a number of a first set of user inputs received while a timer is activated reaches a reference number,
based on identifying that the number of the first set of user inputs reaches the reference number before the timer is expired or identifying that the timer is expired, reset the timer and transmit, to an external electronic device, first information representing the first set of user inputs,
identify whether a number of a second set of user inputs received while the reset timer is activated reaches the reference number, and
based on identifying that the number of the second set of user inputs reaches the reference number before the reset timer is expired or identifying that the reset timer is expired, transmit, to the external electronic device, the first information and second information representing the second set of user inputs with respect to the first set of user inputs.

2. The electronic device of claim 1, wherein the at least one processor is further configured to activate the timer based on identifying obtaining the first set of user inputs.

3. The electronic device of claim 1, wherein the at least one processor is further configured to identify reference time related to a length of the timer and the reference number, based on a data rate of a network comprising the electronic device and the external electronic device.

4. The electronic device of claim 1, wherein first contents corresponding to the first set of user inputs are displayed, via a display of the external electronic device, at first time based on the first information,
wherein second contents corresponding to the first set of user inputs and the second set of user inputs are displayed, via the display of the external electronic device, at second time based on the first information and the second information, and
wherein the first time precedes the second time.

5. The electronic device of claim 4, wherein the second contents, which correspond to the first set of user inputs and the second set of user inputs, comprise the first contents corresponding to the first set of user inputs.

6. The electronic device of claim 1, wherein the first information comprises at least one of position information, pressure information, tilt information, or time information for the first set of user inputs, and
wherein the second information comprises at least one of position information, pressure information, tilt information, or time information for the second set of user inputs.

7. The electronic device of claim 6, wherein the position information indicates a direction from a user input to another user input after the user input,
wherein the pressure information indicates a pressure pressing in a perpendicular direction of the display,
wherein the tile information indicates an angle between a central axis in which a user input is inputted and the perpendicular direction of the display, and
wherein the time information indicates a time when a user input is inputted.

8. A method performed by an electronic device, the method comprising:
identifying whether a number of a first set of user inputs received while a timer is activated reaches a reference number,
based on identifying that the number of the first set of user inputs reaches the reference number before the timer is expired or identifying that the timer is expired, resetting the timer and transmitting, to an external electronic device, first information representing the first set of user inputs,
identifying whether a number of a second set of user inputs received while the reset timer is activated reaches the reference number, and
based on identifying that the number of the second set of user inputs reaches the reference number before the reset timer is expired or identifying that the reset timer is expired, transmitting, to the external electronic device, the first information and second information representing the second set of user inputs with respect to the first set of user inputs.

9. The method of claim 8, the method comprising activating the timer based on identifying obtaining the first set of user inputs.

10. The method of claim 8, further comprising identifying reference time related to a length of the timer and the reference number, based on a data rate of a network related to the electronic device and the external electronic device.

11. The method of claim 8, further comprising:
displaying, via a display of the external electronic device, first contents corresponding to the first set of user inputs at first time, based on the first information, and
displaying, via the display of the external electronic device, second contents corresponding to the first set of user inputs and the second set of user inputs at second time, based on the first information and the second information, and
wherein the first time precedes the second time.

12. The method of claim 11, wherein the second contents, which correspond to the first set of user inputs and the second set of user inputs, comprise the first contents corresponding to the first set of user inputs.

13. The method of claim 8, wherein the first information comprises at least one of position information, pressure information, tilt information, or time information for the first set of user inputs, and
wherein the second information comprises at least one of position information, pressure information, tilt information, or time information for the second set of user inputs.

14. The method of claim 13, wherein the position information indicates a direction from a user input to another user input after the user input,
wherein the pressure information indicates a pressure pressing in a perpendicular direction of the display,
wherein the tile information indicates an angle between a central axis in which a user input is inputted and the perpendicular direction of the display, and
wherein the time information indicates a time when a user input is inputted.

15. An electronic device comprising:
a display; and
at least one processor operatively connected to the display and configured to:
receive, from an external electronic device, first information representing a first set of user inputs of the external electronic device connected to the electronic device,
receive, from the external electronic device, the first information and second information representing a second set of user inputs with respect to the first set of user inputs,
display, via the display, first contents corresponding to the first set of user inputs, based on the first information, and
display, via the display, second contents corresponding to the first set of user inputs and the second set of user inputs, based on the first information and the second information.

16. The electronic device of claim 15, wherein the at least one processor is further configured to consecutively display the second contents with respect to the first contents, based on the first information and the second information.

17. The electronic device of claim 15, wherein the first information comprises at least one of position information, pressure information, tilt information, or time information for the first set of user inputs, and
wherein the second information comprises at least one of position information, pressure information, tilt information, or time information for the second set of user inputs.

18. The electronic device of claim 17, wherein the position information indicates a direction from a user input to another user input after the user input,
wherein the pressure information indicates a pressure pressing in a perpendicular direction of the display,
wherein the tile information indicates an angle between a central axis in which a user input is inputted and the perpendicular direction of the display, and
wherein the time information indicates a time when a user input is inputted.

19. The electronic device of claim 15, wherein the at least one processor is further configured to:
identify whether a difference between first time when the first information is received and second time when the first information and the second information are received is equal to reference time,
based on the difference being equal to the reference time, configure an animation for displaying the second contents during the reference time,
based on the difference being not equal to the reference time, configure the animation for displaying the second contents during time corresponding to the difference, and
display, via the display, the second contents based on the configured animation.

20. The electronic device of claim 19, the at least one processor is further configured to identify the reference time, based on a data rate of a network between the electronic device and the external electronic device or is a predetermined value.
